(19) United States
(12) Patent Application Publication
(10) Pub. No.: US 2021/0172494 A1
(43) Pub. Date: Jun. 10, 2021

(54) AIR SPRING, IN PARTICULAR FOR A VEHICLE, VEHICLE WITH AT LEAST ONE SUCH AIR SPRING AND METHOD FOR OPERATING SUCH AN AIR SPRING

(71) Applicant: AUDI AG, Ingolstadt (DE)

(72) Inventor: Fabian EHRICH, München (DE)

(73) Assignee: AUDI AG, Ingolstadt (DE)

(21) Appl. No.: 17/045,252

(22) PCT Filed: Apr. 23, 2019
(86) PCT No.: PCT/EP2019/060309

§ 371 Date: Oct. 5, 2020

(30) Foreign Application Priority Data
May 7, 2018 (DE) 10 2018 207 076.8

(51) Int. Cl. F16F 9/50; F16F 9/05

(52) U.S. Cl. CPC F16F 9/50; F16F 9/05; B60G 11/27; F16F 2228/066; F16F 2232/08; F16F 2222/126

(57) ABSTRACT

The disclosure relates to an air spring, comprising at least one variable volume air chamber for receiving air, and comprising adsorption material which is arranged in the air chamber, wherein there is an adjusting device by means of which, for the variable adjustment of the rigidity of the air spring, a surface of the adsorption material that is in contact with the air received in the air chamber can be adjusted variably.

The invention relates to an air spring, in particular for a vehicle, according to the preamble of claim 1. Furthermore, the invention relates to a vehicle, in particular a motor vehicle, having at least one such air spring, and a method for operating such an air spring.

Such an air spring, in particular for a vehicle, for example, a motor vehicle, can be inferred to be already known, for example, from WO 2012/052776 A1. The air spring has at least one air chamber for accommodating air, wherein the air chamber is variable or varying in its volume. Moreover, the air spring comprises adsorption material, which is arranged in the air chamber. The adsorption material is also referred to as adsorptive material or as adsorbent material. Furthermore, WO 2015/145148 A1 discloses an air spring.

Moreover, an air spring system is known from EP 2 759 733 A1, which has at least one air spring having at least one compressed air chamber of varying volume. The compressed air chamber is connected to a compressor unit as a compressed air producer with or without a compressed air storage tank. Furthermore, it is provided that compressed air compartments of air springs and/or of the compressed air storage tank are provided with an adsorptive material.

The object of the present invention is to provide an air spring, a vehicle, and a method, so that the air spring can be adjusted particularly advantageously with respect to its spring stiffness.

This object is achieved according to the invention by an air spring having the features of claim 1, by a vehicle having the features of claim 9, and by a method having the features of claim 10. Advantageous designs having expedient refinements of the invention are specified in the other claims.

A first aspect of the invention relates to an air spring, in particular for a vehicle, for example, a motor vehicle. The air spring has at least one air chamber for accommodating air, in particular compressed air. In other words, air, in particular compressed air, can be accommodated or is accommodated in the air chamber. In this case, the air chamber is variable or varying in its volume. This means that the air chamber has a differently variable or varying volume. The air chamber is at least partially delimited, for example, by a bellows, in particular by a rolling bellows, of the air spring, and by a piston of the air spring, wherein the piston is connected to the bellows, for example. During compression and extension movements of the air spring, for example, the piston moves translationally, in particular in relation to at least a part of the bellows, wherein volume increases and volume decreases of the air chamber occur during these translational movements of the piston, i.e., increases and decreases of the volume of the air chamber.

The air spring furthermore has an adsorption material, which is arranged in the air chamber. The adsorption material is also referred to as adsorptive material or adsorbent material and can have activated carbon or can be formed as activated carbon, for example. In particular, the adsorption material is adsorbent for air or air molecules, so that the adsorption material enriches or accumulates air or air molecules on its surface if the adsorption material, in particular its surface, is subjected to air or air molecules, i.e., comes into contact with air or air molecules.

To be able to adjust the air spring particularly advantageously and appropriately with respect to its spring stiffness, which is also referred to as air spring stiffness, air spring hardness, or spring hardness, it is provided according to the invention that the air spring comprises an adjustment device, by means of which a surface of the adsorption material coming into contact with the air accommodated in the air chamber is variably adjustable for the variable adjustment of the spring stiffness of the air spring. In other words, by means of the adjustment device, a part of the surface in contact with the air accommodated in the air chamber or an area or dimension of the surface of the adsorption material in contact with the air accommodated in the air chamber can be varied by means of the adjustment device, i.e., variably adjusted. In particular, it is conceivable that the surface of the adsorption material in contact with the air accommodated in the air chamber can be adjusted by means of the adjustment device to different dimensions or areas, wherein it is conceivable in particular that the surface of the adsorption material in contact with the air accommodated in the air chamber can be adjusted to zero, so that, for example, in at least one state of the adjustment device, the surface of the adsorption material or the adsorption material as a whole is not in contact or does not come into contact with the air accommodated in the air chamber. In particular, it is conceivable that by means of the adjustment device, multiple parts of the surface of the adsorption material, which are different from one another and are each greater than zero, and which are in contact with the air accommodated in the air chamber, can be adjusted, whereby different spring hardnesses or different values of the spring stiffness of the air spring can be adjusted appropriately and in a simple, space-saving, and inexpensive manner.

The invention is based here in particular on the finding that the respective spring stiffness of air springs, also simply referred to as stiffness, is typically directly related to the respective active area and the existing air volume in the respective air chamber. Switchable air springs are known, in which volumes can be activated and deactivated by valves. Depending on the number of the volumes which can be activated and deactivated and which are represented by different volume partitions, a fixed number of discrete spring stiffnesses thus exists. In air springs having volumes which can be activated and deactivated, which are also referred to as switching volumes, only a limited number of discrete spring stiffnesses may thus be represented, wherein these different spring stiffnesses can only be implemented in a very space-intensive manner. In contrast thereto, it is possible in the air spring according to the invention to implement the different spring stiffnesses in a particularly space-saving, weight-saving, and inexpensive manner.

It has proven to be particularly advantageous here if the surface in contact with the air accommodated in the air chamber is adjustable continuously or at least essentially continuously by means of the adjustment device. In this way, an at least essentially continuous adaptation of the spring stiffness, which is also referred to as the spring rate, to different driving states can be implemented, which is not possible in conventional, switchable air springs. Moreover, in conventional, switchable air springs, additional control units are required for each partial volume which can be added, which cause costs and require space. These disadvantages and problems can also be avoided in the air spring according to the invention.

For example, an active regulation of the surface of the absorption material in contact with the air accommodated in the air chamber permits an active regulation of the spring stiffness of the air spring, whereby, for example, a chassis of a vehicle having the air spring can be adapted appropriately to different respective driving situations and different respective roadway states. Rolling and pitching of the vehicle can thus be avoided or at least be kept to a particularly small scope.

A further embodiment is distinguished in that the adjustment device has at least one cover element, wherein the cover element and the adsorption material are movable in relation to one another, wherein a first part of the surface in contact with the air accommodated in the air chamber and a second part of the surface, which adjoins the first part and is separated by means of the cover element from the air accommodated in the air chamber and is thus not in contact with the air accommodated in the air chamber, are variably adjustable. For example, if the first part of the surface is increased, this is thus accompanied by a decrease of the second part and vice versa. In this way, the parts and thus the spring stiffness can be adjusted particularly easily and appropriately.

It has been shown to be particularly advantageous if the cover element is formed to be intrinsically stiff, i.e., dimensionally stable.

In a further design of the invention, the adjustment device has at least one actuator, in particular at least one motor and preferably at least one electric motor, by means of which relative movements between the cover element and the adsorption element can be effectuated to adjust the parts and thus the spring stiffness. The adsorption material forms, for example, an intrinsically stiff or dimensionally stable body in that the adsorption material is, for example, compacted or compressed. Furthermore, it is conceivable that the adsorption material as such is formed as granulated material, which is accommodated, for example, in a container which is air permeable or through which air can flow. Due to the use of the actuator, the surface and thus the spring stiffness can particularly be adjusted appropriately and can be adjusted particularly quickly, so that the air spring can be adapted with respect to its spring stiffness particularly appropriately and particularly quickly to changing driving states and/or roadway states.

One particularly advantageous embodiment of the invention is distinguished in that the cover element and the absorption material are translationally and/or rotationally movable in relation to one another. The surface or the parts and thus the spring stiffness can thus be adjusted particularly appropriately and quickly.

In a further design of the invention, the adjustment device has at least one passage opening, the flow cross section of which through which air can flow, via which the surface can be subjected to the air accommodated in the air chamber and thus brought into contact with it, is adjustable by means of the cover element, in particular by relative movements between the cover element and the absorption material. In particular, it is possible that the adjustment device has a plurality of passage openings separate from one another, the respective flow cross sections of which, through which air can flow and via which the surface can be subjected to air accommodated in the air chamber, are adjustable by means of the cover element, in particular by relative movements between the cover element and the adsorption material. The surface and thus the spring stiffness can be adjusted particularly precisely but also particularly quickly in a large adjustment range in this way, so that, for example, the spring stiffness can be at least essentially continuously adjusted.

The passage openings are distributed, for example, in the circumferential direction of the absorption material, in particular uniformly, so that, for example, while at least partially uncovering the passage openings or the flow cross sections, air molecules can be accumulated or enriched particularly quickly on the surface.

In a further embodiment of the invention, the air spring comprises at least one partition element, which is at least partially arranged in the absorption material and is at least airtight, and by means of which at least one first part of the adsorption material is partitioned or separated from at least one second part of the adsorption material, in particular in an airtight manner. By means of the partition element, for example, undesired airflows occurring within the adsorption material can be avoided. In particular, it is possible to prevent by means of the partition element that, for example, if the surface of the adsorption material in the first part of the adsorption material is uncovered by the adjustment device and at the same time it is still separated from the air accommodated in the air chamber in the second part of the absorption material, in particular in that the adjustment device covers the surface in the second part of the absorption material, in particular to the outside or toward the air chamber, air which can come into contact with the surface of the first part of the adsorption material can flow within the adsorption material from the first part of the adsorption material to the second part of the adsorption material. In other words, with the aid of the partition element, the surface in the second part of the adsorption material within the adsorption material can be kept separated from the first part and thus from the air accommodated in the air chamber, while the surface in the first part of the adsorption material is in contact with the air. The stiffness of the air spring can be adjusted precisely and appropriately in this way.

The partition element is preferably an element different from the adsorption material and provided additionally thereto. In particular, the partition element can be formed from a plastic or from a metallic material. Furthermore, it is conceivable that the partition element is formed from a ceramic material, also referred to as a ceramic substance. Moreover, it is possible that the partition element is formed as an adhesive layer.

It has proven to be particularly advantageous if the partition element is intrinsically stiff and thus dimensionally stable. The parts of the adsorption material can thus be separated from one another particularly well, so that the spring stiffness can be adjusted appropriately and precisely. The partition element could be part of a monolith, which is constructed from various materials. The materials comprise, for example, the adsorption material, which is in particular formed as activated carbon or at least includes activated carbon, and partition material, from which the partition element is formed.

The air spring can be formed as a separate modular unit and can be installable or installed as a separate component, i.e., for example, independently of a shock absorber. It is furthermore conceivable that the air spring is usable or used in a suspension strut and thus forms the suspension strut with a shock absorber. In other words, the air spring is, for example, part of a suspension strut, which includes the air spring and a shock absorber. The invention thus also includes a suspension strut which includes at least one air spring according to the invention.

A second aspect of the invention relates to a vehicle, in particular a motor vehicle. The vehicle is preferably designed as an automobile, in particular as a passenger vehicle. The vehicle includes at least one air spring according to the invention according to the first aspect of the invention. Advantages and advantageous designs of the first aspect of the invention are to be considered advantages and advantageous designs of the second aspect of the invention and vice versa.

A third aspect of the invention relates to a method for operating an air spring, in particular an air spring according to the invention according to the first aspect of the invention. In the third aspect of the invention, the air spring includes at least one air chamber variable in its volume for accommodating air an adsorption material arranged in the air chamber. In the method for operating the air spring, its spring stiffness or spring hardness is variably adjusted in that a surface of the adsorption material in contact with the air accommodated in the air chamber is variably adjusted by means of an adjustment device. Advantages and advantageous designs of the first aspect and the second aspect of the invention are to be considered advantages and advantageous designs of the third aspect of the invention and vice versa.

The invention also includes refinements of the method according to the invention which have features as have already been described in conjunction with the refinements of the air spring according to the invention and the motor vehicle according to the invention. For this reason, the corresponding refinements of the method according to the invention are not described once again here. The invention also comprises the combinations of the features of the described embodiments.

Exemplary embodiments of the invention are described hereinafter. In the figures:

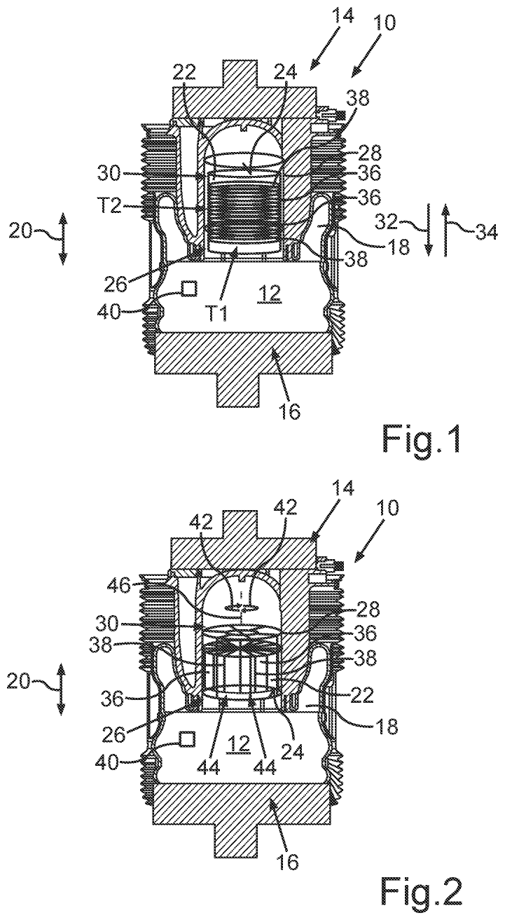

FIG. 1 shows a schematic and sectional side view of an air spring according to the invention according to a first embodiment; and

FIG. 2 shows a schematic and sectional side view of the air spring according to a second embodiment.

The exemplary embodiments explained hereinafter are preferred embodiments of the invention. In the exemplary embodiments, the described components of the embodiments each represent individual features of the invention to be considered independently of one another, which each also refine the invention independently of one another and are thus also to be considered part of the invention individually or in a combination other than that shown. Furthermore, the described embodiments can also be supplemented by further ones of the features of the invention already described.

In the figures, identical reference signs each identify functionally identical elements.

FIG. 1 shows a schematic side view of an air spring 10 for a motor vehicle according to the invention, in particular for an automobile which is designed, for example, as a passenger vehicle. The air spring 10 is, for example, part of a chassis of the motor vehicle, which the chassis comprises in the completely produced state of the motor vehicle. For example, in the completely produced state of the motor vehicle, at least one wheel of the motor vehicle is supported at least sprung on a body of the motor vehicle, designed, for example, as a self-supporting body, via the air spring 10.

The air spring 10 has at least one air chamber 12, which is variable in its volume. In other words, the air chamber 12 has a variable volume. Air, in particular compressed air, can be accommodated or is accommodated in the air chamber 12. The chamber 12 is, for example, partially delimited respectively by a first attachment element 14, a second attachment element 16, and a bellows 18 of the air spring 10, also referred to as a spring bellows or air spring bellows. In this case, the bellows 18 is connected, for example, to the respective attachment elements 14 and 16. The air spring 10 is at least indirectly attachable to the body via the attachment element 14, for example. In other words, the air spring 10 can be supported at least indirectly on the body or coupled to the body, for example, via the attachment element 14. For example, the air spring 10 can be supported via the attachment element 14 on a spring dome and/or shock absorber dome of the body, in particular can be connected to the spring dome and/or shock absorber dome, which is also simply referred to as a dome. Expressed again in other words, the attachment element 14 is used, for example, for the vehicle-side attachment of the air spring 10.

The air spring 10 can be coupled to the above-mentioned wheel via the attachment element 16, so that, for example, the attachment element 16 is used for the wheel-side attachment of the air spring 10.

One of the attachment elements 14 and 16 comprises, for example, a piston or is designed as a piston, wherein the piston is designed, for example, as a rolling piston. In this case, the bellows 18 is designed as a rolling bellows, for example, which rolls on the rolling piston during compression and extension movements. During compression and extension movements of the air spring 10, translational relative movements occur between the attachment elements 14 and 16. For example, the attachment elements 14 and 16 move translationally toward one another during a compression movement, so that the rolling bellows is at least partially rolled onto the rolling piston. During an extension movement, the attachment elements 14 and 16 move translationally away from one another, so that the rolling bellows is at least partially unrolled from the rolling piston. Other embodiments or structural variants of the air spring 10 are readily conceivable. During the compression movement, a decrease of the volume of the air chamber 12 occurs, wherein an increase of the volume of the air chamber 12 occurs during the extension movement. The compression and extension movements and thus the translational relative movements between the attachment elements 14 and 16 are illustrated in FIG. 1 by a double arrow 20 or take place along a direction illustrated by the double arrow 20 in FIG. 1.

The air spring 10 additionally comprises adsorption material 22, which is arranged in the air chamber 12, which is partially delimited or formed by each of the attachment elements 14 and 16 and the bellows 18. The adsorption material 22 is also referred to as adsorptive material or as adsorbent material and is, for example, a material which absorbs at least air or at least or exclusively air molecules, so that, for example, at least or exclusively air molecules enrich or accumulate on the adsorption material 22, in particular on its surface 24. In other words, the adsorption material 22 is designed, for example, to absorb air or air molecules.

To now be able to adjust the air spring 10 particularly advantageously with respect to its spring stiffness, also referred to as spring hardness, air spring hardness, or air spring stiffness, the air spring 10 comprises an adjustment device 26 arranged in the air chamber 12, by means of which the surface 24 of the adsorption material 22 in contact with the air accommodated in the air chamber 12 can be variably adjusted to variably adjust the spring stiffness of the air spring 10. In this case, FIG. 1 shows a first embodiment of the air spring 10. In particular, it can be provided, for example, that the spring stiffness can be adjusted at least essentially continuously or in steps, in particular if individual segments of the adsorption material 22 separate from one another are provided. These steps can be very small and can have a high number, so that the spring hardness can be adjusted very precisely to different values, the number of which can correspond, for example, to the number of the steps or the segments.

FIG. 1 shows a first embodiment of the air spring 10. In the first embodiment, the adjustment device 26 comprises at least or precisely one housing element 28 functioning as a cover element, which delimits or forms at least or precisely one receptacle compartment 30. The housing element 28 and the adsorption material 22 can be moved in relation to one another, in particular translationally, to adjust the surface 24 in contact with the air accommodated in the air chamber 12 and thus to adjust the spring stiffness. By way of translational movement of the adsorption material 22 and the housing element 28 in relation to one another, the adsorption material 22 can be moved into the receptacle compartment 30 and moved out of the receptacle compartment 30. In other words, for example, if the adsorption element 22 and the housing element 28 are moved in relation to one another in a first direction, the adsorption material 22 is thus, for example, at least partially moved out of the receptacle compartment 30 and thus out of the housing element 28. The first direction coincides, for example, with the direction illustrated by the double arrow 20 and is illustrated in FIG. 1 by an arrow 32. If the adsorption material 22 and the housing element 28 are moved in relation to one another, in particular translationally, in a second direction opposite to the first direction and illustrated by an arrow 34 in FIG. 1, thus, for example, the adsorption material 22 is at least partially moved into the receptacle compartment 30 and thus into the housing element 28. The second direction coincides, for example, with the direction illustrated by the double arrow 20. By moving the adsorption material 22 out of the receptacle compartment 30, the surface of the absorption material 22 which is in contact with the air accommodated in the air chamber 12 is increased, so that an effective air volume of the air spring 10 influencing the spring stiffness of the air spring 10 is increased. The effective air volume is increased, since due to the moving of the adsorption material 22 out and the accompanying increase of the surface which is in contact with the air accommodated in the air chamber 12, additional air molecules accumulate on the adsorption material 22, in particular on its surface 24. This results in a reduction of the spring stiffness with equal structural space.

By moving the adsorption material 22 into the receptacle compartment 30, the surface of the adsorption material 22 in contact with the air accommodated in the air chamber 12 is decreased, whereby the effective air volume is decreased. In this way, the spring stiffness of the air spring 10 is increased. In particular, the adsorption material 22 and the housing element 28 can be moved at least essentially continuously in relation to one another, in particular translationally, whereby the spring stiffness of the air spring 10 is adjusted at least essentially continuously, i.e., can be adjusted to values different from one another and in relation to only greater values.

The housing element 28 and the adsorption material 22 can be moved into different positions in relation to one another in that the housing 28 and the adsorption material 22 are moved in relation to one another. One of the positions is shown in FIG. 1. In the one position shown in FIG. 1, a first part T1 of the surface 24 is in contact with the air accommodated in the air chamber 12, while a second part T2 adjoining the first part T1 is separated by means of the housing element 28 from the air accommodated in the air chamber 12, since the first part T1 is arranged outside the housing element 28, while the part T2 is accommodated in the receptacle chamber 30 and thus in the housing element 28. By moving the housing element 28 and the adsorption material 22 in relation to one another, the parts T1 and T2 can be adjusted appropriately and at the same time at least essentially continuously.

Overall, it is apparent that depending on the state of the adjustment device 26, an air exchange can occur between surface-proximal air molecules and the working volume of the air spring 10, whereby the spring stiffness can be set appropriately. The adjustment device 26 is in this case an at least essentially continuously adjustable mechanism, by means of which the part T1, which is in contact with the air accommodated in the air chamber 12, and the part T2, which is fluidically separated from the air accommodated in the air chamber 12, can be gradually varied. The respective part T1 and T2 is also referred to as a respective proportion, wherein the part T1 is also referred to as an adjustable active surface of the adsorption material 22, since additional air molecules can accumulate on the part T1 and thus on the adjustable active surface, in particular by absorption. The number of active air molecules can be variably adjusted by this adjustable active surface, whereby the active air volume of the air spring 10 and thus its spring stiffness can be variably adjusted.

If, for example, the adsorption material 22 is moved farther out of the housing element 28 starting from the one position shown in FIG. 1, the part T1 is thus increased, while the part T2 is decreased. However, if the adsorption material 22 is moved farther into the housing element 28 and thus into the receptacle chamber 30 starting from the one position shown in FIG. 1, the part T1 is thus decreased while the part T2 is increased. Preferably, in each case multiple values different from one another and greater than zero of the parts T1 and T2 are adjustable. Furthermore, it is provided, for example, that the respective part T1 or T2 can be adjusted to zero, so that, for example, all of the adsorption material 22 can be arranged in the receptacle chamber 30 and thus separated from the air accommodated in the air chamber 12 and, for example, all of the adsorption material 22 can thus be arranged outside the receptacle chamber 30 and can thus come into contact with the air accommodated in the air chamber 12.

For example, to prevent air or air molecules within the adsorption material 22 from flowing from the part T1 arranged outside the receptacle chamber 30 into the part T2 still arranged in the receptacle chamber 30, the adsorption material 22 is divided into multiple partitions 36, also referred to as parts, wherein these partitions 36 are arranged successively or one behind another along the respective direction, for example, and are preferably separated from one another fluidically or in an airtight manner. To allocate or divide the adsorption material 22 into the partitions 36, multiple airtight partition elements 38 are provided. The partition elements 38 are arranged in succession or one behind another along the respective direction and are spaced apart from one another at the same time, so that, for example, the respective partition 36 of the adsorption material 22 adjoins the respective partition element 38, in particular directly, along the respective direction. The partition elements 38 are each arranged at least partially, in particular at least predominantly or completely, in the adsorption material 22 and are airtight, so that air cannot flow through the partition elements 38. Thus, only the partitions 36, which are arranged outside the receptacle chamber 30, come into contact with the air accommodated in the air chamber 12, while the partitions 36, which are still accommodated in the receptacle chamber 30 during this, do not come into contact with the air accommodated in the air chamber 12. The surface in contact with the air accommodated in the air chamber 12 or the respective part T1 or T2, respectively, can thus be adjusted particularly precisely and appropriately, so that the spring stiffness of the air spring 10 can be adjusted appropriately. In other words, an undesired air exchange within the adsorption element 22 formed as activated carbon, for example, can be prevented by the partition elements 38.

In the first embodiment shown in FIG. 1, the air spring 10 comprises, for example, a motor 40, which is shown particularly schematically in FIG. 1 and is designed, for example, as an electric motor, and by means of which the above-described relative movements can be effectuated between the housing element 28 and the adsorption material 22. In other words, the adsorption material 22 and the housing element 28 can be moved in relation to one another, in particular translationally, by means of the motor 40. The motor 40 is thus an actuator, by means of which the relative movements can be effectuated between the housing element 28 and the adsorption material 22. For example, it is possible that the housing element 28 is immovable in relation to the attachment element 14, so that, for example, the adsorption material 22 can be moved, in particular translationally, by means of the motor 40 in relation to the housing element 28 and in relation to the attachment element 14. Alternatively thereto, it is conceivable that the adsorption material 22 is immovable in relation to the attachment element 14, so that, for example, the housing element 28 is movable, in particular translationally, by means of the motor 40 in relation to the adsorption element 22 and in relation to the attachment element 14. In the first embodiment, the housing element 28 and the adsorption material 22 are exclusively movable translationally in relation to one another to thus adjust the spring stiffness.

FIG. 2 shows a second embodiment of the air spring 10. In the second embodiment, the housing element 28 functioning as a cover element is, for example, rotationally movable in relation to the adsorption material 22, i.e., rotatable, which is illustrated by arrows 42 in FIG. 2. This means, for example, that in the second embodiment, the adsorption material 22 and the housing element 28 can be rotated in relation to one another by means of the motor 40 and at the same time can be exclusively rotationally moved in relation to one another, for example, to adjust the spring stiffness of the air spring 10.

In the second embodiment, the housing element 28 functions, for example, as a sealing washer, by means of which respective flow cross sections of respective passage openings 44 of the adjustment device 26 through which air can flow can be adjusted. For example, the adsorption material 22 and the housing element 28 are rotatable in relation to one another around a rotational axis 46, to thereby adjust the active surface in contact with the air accommodated in the air chamber 12 and thus adjust the spring stiffness. In this case, for example, the passage openings 44 are arranged distributed in the circumferential direction of the adsorption material 22 extending around the rotational axis, in particular uniformly, and are separated from one another at the same time. The passage openings 44 are delimited, for example, by walls of the adjustment device 26, in particular a cover part of the adjustment device 26, and separated from one another, wherein, for example, the adsorption material 22 is arranged in the cover part. The cover part is arranged here, for example, in the housing element 28. The housing element 28 has further walls here, by means of which the passage openings 44 can be closed and uncovered to adjust the flow cross sections. If, for example, the housing element 28 is rotated in a first rotational direction around the rotational axis 46 in relation to the mentioned cover part, the passage openings 44 and thus their cross-sections are at least partially closed thereby. However, for example, if the housing element 28 is rotated in relation to the cover part in a second rotational direction opposite to the first rotational direction, the passage openings 44 and thus their flow cross sections are thereby uncovered. By uncovering the flow cross sections, the adjustable active surface which is in contact or comes into contact with the air accommodated in the air chamber 12 is enlarged. By blocking or decreasing the flow cross sections, the adjustable active surface is reduced. In this manner, the adjustable active surface and thus the spring stiffness of the air spring 10 can be adjusted particularly precisely, easily, and in a space-saving manner. In particular, the spring stiffness can be adjusted and thus varied continuously, so that the air spring 10 can be adapted particularly flexibly or appropriately to different driving situations and/or roadway states. As a result, rolling and pitching of the motor vehicle can be prevented or at least kept particularly minor. In particular, the adsorption material 22 and the housing element 28 can be moved without steps in relation to one another, so that the spring stiffness can be adjusted continuously.

1-10. (canceled)

11. An air spring comprising:
at least one air chamber variable in its volume for accommodating air, and having adsorption material, which is arranged in the air chamber, an adjustment device, by which a surface of the adsorption material in contact with the air accommodated in the air chamber is variably adjustable for the variable adjustment of a spring stiffness of the air spring.

12. The air spring as claimed in claim 11, wherein the surface in contact with the air accommodated in the air chamber is continuously adjustable by the adjustment device.

13. The air spring as claimed in claim 11, wherein the adjustment device has at least one cover element, wherein the cover element and the adsorption material are movable in relation to one another, whereby a first part of the surface in contact with the air accommodated in the air chamber and a second part of the surface adjoining the first part and separated by means of the cover element from the air accommodated in the air chamber are variably adjustable.

14. The air spring as claimed in claim 13, wherein the adjustment device has at least one motor, in particular an electric motor, by which relative movements between the cover element and the adsorption material can be effectuated to adjust the parts.

15. The air spring as claimed in claim 13, wherein the cover element and the adsorption material are movable translationally and/or rotationally in relation to one another.

16. The air spring as claimed in claim 13, wherein the adjustment device has at least one passage opening, the flow cross section of which—through which air can flow—via which the surface can be subjected to the air accommodated in the air chamber, is adjustable by means of the cover element, in particular by relative movements between the cover element and the adsorption material.

17. The air spring as claimed in claim 11, wherein at least one partition element, which is at least partially arranged in the adsorption material and is at least airtight, and by means of which a first part of the adsorption material is separated from at least one second part of the adsorption material.

18. The air spring as claimed in claim 17, wherein the partition element is intrinsically stiff.

19. A method for operating an air spring, comprising:
at least one air chamber variable in its volume for accommodating air and adsorption material arranged in the air chamber, the spring stiffness of which is variably adjusted in that a surface of the adsorption material in contact with the air accommodated in the air chamber is variably adjusted by an adjustment device.

20. The air spring as claimed in claim 12, wherein the adjustment device has at least one cover element, wherein the cover element and the adsorption material are movable in relation to one another, whereby a first part of the surface in contact with the air accommodated in the air chamber and a second part of the surface adjoining the first part and separated by means of the cover element from the air accommodated in the air chamber are variably adjustable.

21. The air spring as claimed in claim 14, wherein the cover element and the adsorption material are movable translationally and/or rotationally in relation to one another.

22. The air spring as claimed in claim 14, wherein the adjustment device has at least one passage opening, the flow cross section of which—through which air can flow—via which the surface can be subjected to the air accommodated in the air chamber, is adjustable by means of the cover element, in particular by relative movements between the cover element and the adsorption material.

23. The air spring as claimed in claim 15, wherein the adjustment device has at least one passage opening, the flow cross section of which—through which air can flow—via which the surface can be subjected to the air accommodated in the air chamber, is adjustable by means of the cover element, in particular by relative movements between the cover element and the adsorption material.

24. The air spring as claimed in claim 12, wherein at least one partition element, which is at least partially arranged in the adsorption material and is at least airtight, and by means of which a first part of the adsorption material is separated from at least one second part of the adsorption material.

25. The air spring as claimed in claim 13, wherein at least one partition element, which is at least partially arranged in the adsorption material and is at least airtight, and by means of which a first part of the adsorption material is separated from at least one second part of the adsorption material.

26. The air spring as claimed in claim 14, wherein at least one partition element, which is at least partially arranged in the adsorption material and is at least airtight, and by means of which a first part of the adsorption material is separated from at least one second part of the adsorption material.

27. The air spring as claimed in claim 15, wherein at least one partition element, which is at least partially arranged in the adsorption material and is at least airtight, and by means of which a first part of the adsorption material is separated from at least one second part of the adsorption material.

28. The air spring as claimed in claim 16, wherein at least one partition element, which is at least partially arranged in the adsorption material and is at least airtight, and by means of which a first part of the adsorption material is separated from at least one second part of the adsorption material.
